(19) United States
(12) Patent Application Publication
(10) Pub. No.: US 2013/0153757 A1
(43) Pub. Date: Jun. 20, 2013

(54) WAVEGUIDE PHOTOMIXER

(71) Applicants: Taeyong KIM, Daejeon (KR); Sungil KIM, Daejeon (KR); Min Hwan KWAK, Daejeon (KR); Seungbeom KANG, Chungcheongbuk-do (KR); Kwang-Yong KANG, Daejeon (KR)

(72) Inventors: Taeyong KIM, Daejeon (KR); Sungil KIM, Daejeon (KR); Min Hwan KWAK, Daejeon (KR); Seungbeom KANG, Chungcheongbuk-do (KR); Kwang-Yong KANG, Daejeon (KR)

(73) Assignee: ELECTRONIC AND TELECOMMUNICATIONS RESEARCH INSTITUTE, Daejeon (KR)

(21) Appl. No.: 13/608,547

(22) Filed: Sep. 10, 2012

(30) Foreign Application Priority Data
Dec. 14, 2011 (KR) 10-2011-0134348

(51) Int. Cl. G01J 1/04

(52) U.S. Cl. 250/227.11

(57) ABSTRACT

Provided is a waveguide photomixer in which an absorption layer is selectively etched to reduce a junction area. The waveguide photomixer includes a buffer layer disposed on a substrate, a first clad layer disposed on the buffer layer and formed to have smaller width than that of a top surface of the buffer layer, an absorption layer disposed on the first clad layer and formed to have smaller width than that of a top surface of the first clad layer, a second clad layer disposed on the absorption layer and formed to have greater width than that of a top surface of the absorption layer, a contact layer disposed on the second clad layer, a first electrode unit disposed on the buffer layer where the first clad layer is not disposed, and a second electrode unit disposed on the contact layer.

### CROSS-REFERENCE TO RELATED APPLICATIONS

This U.S. non-provisional patent application claims priority under 35 USC §119 to Korean Patent Application No. 10-2011-0134348, filed on Dec. 14, 2011, the entirety of which is hereby incorporated by reference.

### BACKGROUND OF THE INVENTION

The present general inventive concept relates to waveguide photomixers and, more particularly, to waveguide photomixers with improve operating speed and responsivity.

A main object of a photomixer is to receive light that is an optical signal and generate an electron-hole pair that is an electrical signal. In general, a photomixer is formed of a semiconductor. An absorption layer (or intrinsic layer) of a widely used P-doped intrinsic N-doped (PIN) photomixer is disposed to be sandwiched between a

P-doped layer and an N-doped layer. A typical surface-illuminated type PIN photomixer has a window aperture formed in a P-doped or N-doped layer to externally receive light.

Absorbed light is converted to an electron-hole pair. At this point, a reversely applied electric field allows an electron to pass through an N-doped layer and allows a hole to pass through a P-doped layer and migrate to N/P-electrodes. A manufacturing object of a photomixer is to use current generated by migration of an electron and a hole. The most significant performance factors of the photomixer are responsivity and operation speed. In case of such a surface-illuminated PIN photomixer, responsivity and operating speed have a trade-off relationship. Therefore, a surface-illuminated PIN photomixer is limited in concurrently improving responsivity and operating speed. The responsivity is related to an area or length of a light-absorbed region, and the operating speed is restricted by migration time of the generated and an RC time constant. Accordingly, there is a need for reducing migration distance of the electron-hole pair and the RC time constant to improve response speed.

### SUMMARY OF THE INVENTION

Embodiments of the inventive concept provide a waveguide photomixer. In some embodiments, the waveguide photomixer may include a buffer layer disposed on a substrate; a first clad layer disposed on the buffer layer and formed to have smaller width than that of a top surface of the buffer layer; an absorption layer disposed on the first clad layer and formed to have smaller width than that of a top surface of the first clad layer; a second clad layer disposed on the absorption layer and formed to have greater width than that of a top surface of the absorption layer; a contact layer disposed on the second clad layer; a first electrode unit disposed on the buffer layer where the first clad layer is not disposed; and a second electrode unit disposed on the contact layer.

According to an example embodiment, the absorption layer may have a smaller junction area than that of the first and second clad layers.

According to an example embodiment, the buffer layer, the first clad layer, the absorption layer, the second clad layer, and the contact layer may be sequentially stacked to be formed. On the basis of a central region, both sides of the contact layer, the second clad layer, the absorption layer, and the first clad layer may be etched to form a mesa structure.

According to an example embodiments, the buffer layer may be an N-buffer layer, the first clad layer may be an N-clad layer doped with N-type impurities, the second clad layer may be a P-clad layer doped with P-type impurities, the contact layer may be a P-contact layer, the first electrode unit may be an N-electrode unit, and the second electrode unit may be a P-electrode unit.

According to an example embodiment, the waveguide photomixer may further include a high-reflection layer disposed on a surface opposite to a light-impinging surface of the mesa structure to re-reflect light passing through the absorption layer to the absorption layer.

According to an example embodiment, the high-reflection layer may be made of a single layer of metallic material or a single layer of dielectric.

According to an example embodiment, the high-reflection layer may be made of the same material as the P-electrode unit and formed simultaneously to formation of the P-electrode unit.

According to an example embodiment, the high-reflection layer may be made of one of Ti/Au, Ti/Pt/Au, and Ti/Pt/Au/Ni.

According to an example embodiment, the high-reflection layer may be formed by stacking a plurality of dielectrics with different refractive indexes.

According to an example embodiment, the absorption layer may be made of InGaAs, and the first and second clad layers may be made of InGaAsP or InP.

According to an example embodiment, a refractive index of the first and second clad layers may be lower than that of the absorption layer.

According to an example embodiment, the waveguide photomixer may further include a protection layer disposed on the buffer layer and a side surface of the mesa structure to block current and achieve electrical isolation between elements.

### BRIEF DESCRIPTION OF THE DRAWINGS

The inventive concept will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the inventive concept.

FIG. 1 is a cross-sectional view of a waveguide photomixer according to an embodiment of the inventive concept.

FIG. 2 is a perspective view of the waveguide photomixer in FIG. 1.

FIG. 3 is a cross-sectional view of a waveguide photomixer according to another embodiment of the inventive concept.

FIG. 4 is a perspective view of the waveguide photomixer in FIG. 3.

FIG. 5 is a perspective view of a waveguide photomixer according to another embodiment of the inventive concept.

FIG. 6 is a cross-sectional view taken along the line I-I′ of a waveguide photomixer in FIG. 5.

### DETAILED DESCRIPTION

The advantages, features, and aspects of the inventive concept will become apparent from the following description of the embodiments with reference to the accompanying drawings, which is set forth hereinafter. Therefore, those skilled in the field of this art of the inventive concept can embody the technological concept and scope of the invention easily. In addition, if it is considered that detailed description on a related art may obscure the points of the inventive concept, the detailed description will not be provided herein. The preferred embodiments of the inventive concept will be described in detail hereinafter with reference to the attached drawings.

Unlike a typical surface-illuminated PIN photomixer, a waveguide photomixer is configured such that light does not vertically impinge from a surface side or a substrate side but horizontally impinge from a cut surface. This configuration is advantageous in decreasing junction capacitance, as compared to the typical surface-illuminated PIN photomixer, because an area of the PN junction need not be extended to extend an area of a light receiving region on which light impinges. The junction capacitance is in inverse proportion to thickness of an absorption layer and in proportion to a junction area. Accordingly, there are two ways to reduce the junction capacitance. One way is to extend the junction area, and the other is to increase the thickness of an absorption layer.

In case of a surface-illuminated PIN photomixer where light impinges vertically, junction capacitance may be reduced by decreasing an area of a window aperture through which the light impinges. However, if the area of the window aperture decreases, the amount of the light absorbed into the photomixer also decreases. Although the junction capacitance may also be reduced by increasing the thickness of an absorption layer, migration distance of an electron and a hole increases when the thickness of an absorption layer increases above a predetermined value. For this reason, increasing the thickness of an absorption layer is not effective in improving the operating speed of the photomixer. A waveguide photomixer according to an embodiment of the inventive concept may overcome the trade-off relationship between responsivity and operating speed.

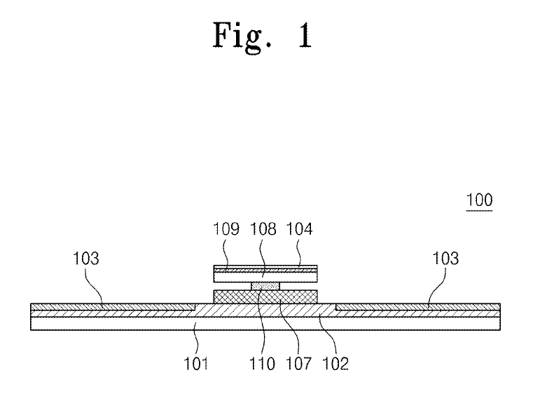

Reference is made to FIG. 1, which is a cross-sectional view of a waveguide photomixer 100 according to an embodiment of the inventive concept. The waveguide photomixer 100 includes a substrate 101, a buffer layer 102, a first clad layer 107, an absorption layer 110, a second clad layer 108, a contact layer 109, a first electrode unit 103, and a second electrode unit 104.

The buffer layer 102 is disposed on the substrate 101, serving as a boundary between the substrate 101 and other layers to be stacked on the buffer layer 102. The first clad layer 107 and the first electrode unit 103 may be stacked on the buffer layer 102, and a lower portion of the buffer layer 103 is in contact with the substrate 101.

The first clad layer 107 is disposed on the buffer layer 102. Width of the first clad layer 107 is smaller than that of a top surface of the buffer layer 102. One of an electron and a hole generated by light absorbed to the absorption layer 110 migrates to the first electrode 103 through the first clad layer 107 due to an electric field applied through the first electrode unit 103 and the second electrode unit 104.

The absorption layer 110 is disposed on the first clad layer 107. Width of the absorption layer 110 is smaller than that of a top surface of the first clad layer 107. Since the absorption layer 110 is disposed between the first clad layer 107 and the second clad layer 108 and formed by removing a portion of the absorption layer 110 through a selective etching process, a junction area of the absorption layer 110 is smaller than that of the first clad layer 107 and the second clad layer 108. Junction capacitance is in reverse proportion to thickness of an absorption layer and in proportion to a junction area. Therefore, if a junction area is small like the absorption layer 110 included in the waveguide photomixer 100 according to the embodiment of the inventive concept, the junction capacitance decreases. As a result, an RC time constant determining operating speed of a photomixer is reduced to improve the operating speed of the photomixer.

The second clad layer 108 is disposed on the absorption layer 110. Width of the clad layer 108 is greater than that of a top surface of the absorption layer 110. One of an electron and a hole generated by the light absorbed to the absorption layer 110 migrates to the second electrode unit 104 through the second clad layer 108 due to an electric field applied through the first electrode unit 103 and the second electrode unit 104.

The contact layer 109 is disposed on the second clad layer 108. The contact layer 109 serves as a boundary between the second electrode 104 and the second clad layer 108. One of the electron and the hole passing through the second clad layer 108 passes through the contact layer 109 while migrating to the second electrode unit 104.

The first electrode unit 103 is disposed on the buffer layer 102 where the first clad layer 107 is not formed, and the second electrode unit 104 is disposed on the contact layer 109. A reverse voltage may be applied to the first clad layer 107 and the second clad layer 108, sandwiching the absorption layer 110, through the first electrode unit 103 and the second electrode unit 104. Thus, due to an applied electric field, one of an electron or a hole generated by light migrates to the first electrode unit 103 through the first clad layer 107 and the other migrates to the second electrode unit 104 through the second clad layer 108. Light-generating current is generated by the migration of the electron or the hole. The generated light-generating current may be used with a load resistor in an external entity.

The waveguide photomixer 100 according to the embodiment of the inventive concept is characterized in that the absorption layer 110 is partially removed through an selective etching process to have a smaller junction area than the first clad layer 107 and the second clad layer 108. Since the junction area of the absorption layer 110 is small, its junction capacitance is lower than that of a typical waveguide photomixer. As a result, an RC time constant determining operating speed of a photomixer is reduced to improve the operating speed of the photomixer.

The buffer layer 102, the first clad layer 107, the absorption layer 110, the second clad layer 108, and the contact layer 109 included in the waveguide photometer 100 according to the embodiment of the inventive concept may be sequentially stacked to be formed. In addition, on the basis of a central region, both sides of the contact layer 109, the second clad layer 108, the absorption layer 110, and the first clad layer 107 may be etched to form a mesa structure.

The buffer layer 102 included in the waveguide photomixer 100 according to the embodiment of the inventive concept may be an N-buffer layer, the first clad layer 107 may be an N-clad layer doped with N-type impurities, the second clad layer 108 may be a P-clad layer doped with P-type impurities, and the contact layer 109 may be a P-contact layer. In this embodiment, the first electrode unit 103 may be an N-electrode unit and the second electrode unit 104 may be a P-electrode unit. That is, an electron generated by light absorbed to the absorption layer 110 migrates to an N-electrode unit through an N-clad layer doped with N-type impurities, and a hole generated by the light absorbed to the absorption layer 110 migrates to a P-electrode unit through a P-clad layer doped with P-type impurities.

The absorption layer 110 included in the waveguide photomixer 100 according to the embodiment of the inventive concept may be made of InGaAs, and the first clad layer 107 and the second clad layer 108 may be made of InGaAsP or InP. In addition, a material of the first and second clad layers 107 and 108 may be selected such that a refractive index of the first and second clad layers 107 and 108 is smaller than that of the absorption layer 110.

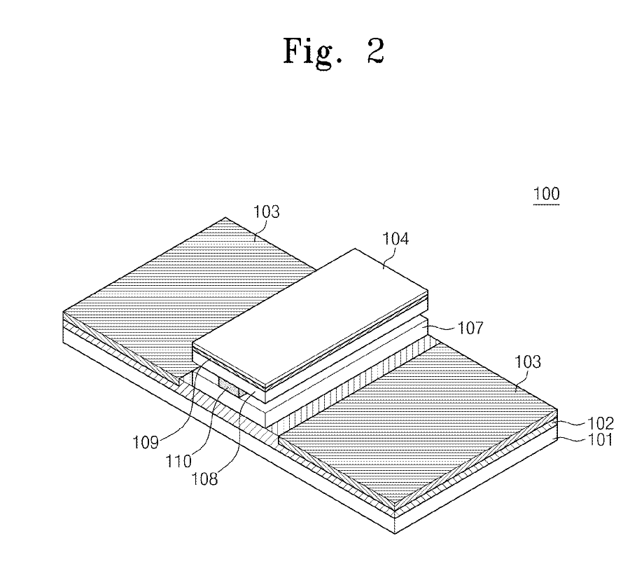

Reference is made to FIG. 2, which is a perspective view of the waveguide photomixer 100 in FIG. 1. The waveguide photomixer 100 includes a substrate 101, a buffer layer 102, a first clad layer 107, an absorption layer 110, a second clad layer 108, a contact layer 109, a first electrode unit 103, and a second electrode unit 104.

The substrate 101, the buffer layer 102, the first clad layer 107, the absorption layer 110, the second clad layer 108, the contact layer 109, the first electrode unit 103, and the second electrode unit 104 in FIG. 2 are identical to those explained in FIG. 1 and will not be explained in further detail.

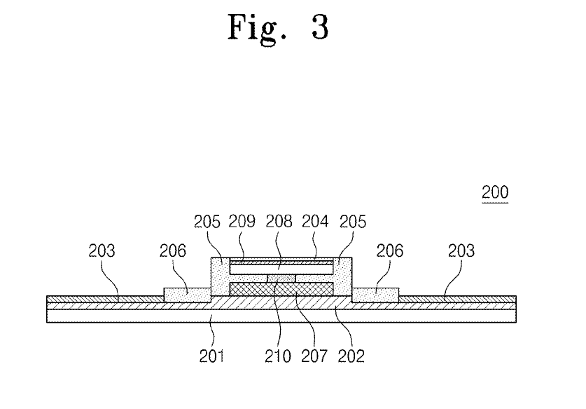

Reference is made to FIG. 3, which is a cross-sectional view of a waveguide photometer 200 according to another embodiment of the inventive concept. The waveguide photometer 200 includes a substrate 201, a buffer layer 202, a first clad layer 207, an absorption layer 210, a second clad layer 208, a contact layer 209, a first electrode unit 203, a second electrode unit 204, and protection layers 205 and 206. The substrate 201, the buffer layer 202, the first clad layer 207, the absorption layer 210, the second clad layer 208, the contact layer 209, the first electrode unit 203, and the second electrode unit 204 in FIG. 3 are identical to those explained in FIG. 1 and will not be explained in further detail.

The waveguide photomixer 200 includes the protection layers 205 and 206 disposed on the buffer layer 202 and a side surface of a mesa structure to block current and achieve electrical isolation between elements. The protection layers 205 and 206 having semi-insulating characteristics by InP may be made of a low-k dielectric polymer such as polyimide or benzo-cyclo-butene (BCB).

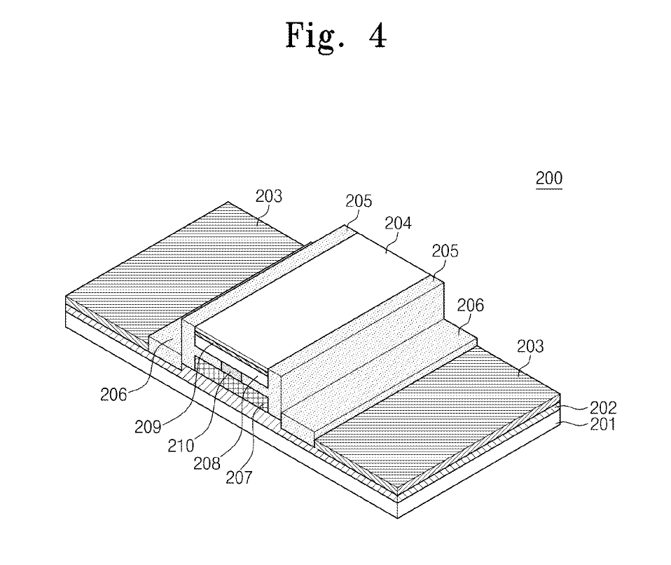

Reference is made to FIG. 4, which is a perspective view of the waveguide photomixer 200 in FIG. 3. The waveguide photomixer 200 includes a substrate 201, a buffer layer 202, a first clad layer 207, an absorption layer 210, a second clad layer 208, a contact layer 209, a first electrode unit 203, a second electrode unit 204, and protection layers 205 and 206. The substrate 201, the buffer layer 202, the first clad layer 207, the absorption layer 210, the second clad layer 208, the contact layer 209, the first electrode unit 203, the second electrode unit 204, and the protection layers 205 and 206 in FIG. 4 are identical to those explained in FIGS. 1 and 3 and will not be explained in further detail.

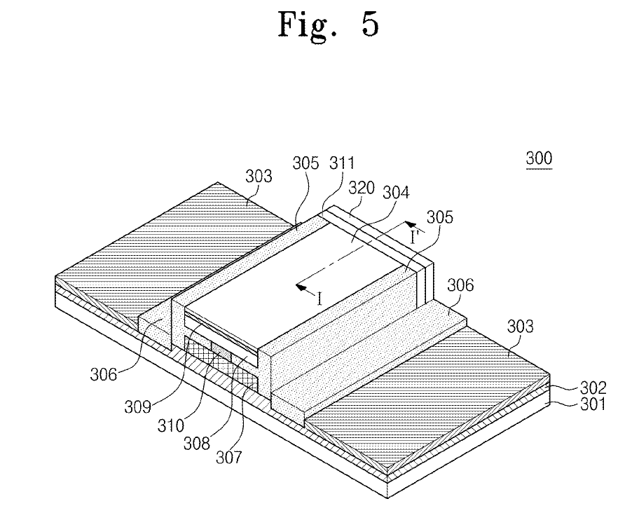

Reference is made to FIG. 5, which is a perspective view of a waveguide photomixer 300 according to still another embodiment of the inventive concept. The waveguide photomixer 300 includes a substrate 301, a buffer layer 302, a first clad layer 307, an absorption layer 310, a second clad layer 308, a contact layer 309, a first electrode unit 303, a second electrode unit 304, protection layers 305, 306, and 311, and a high-reflection layer 320. The substrate 301, the buffer layer 302, the first clad layer 307, the absorption layer 310, the second clad layer 308, the contact layer 309, the first electrode unit 303, the second electrode unit 304, and the protection layers 305 and 306 in FIG. 5 are identical to those explained in FIGS. 1 and 3 and will not be explained in further detail.

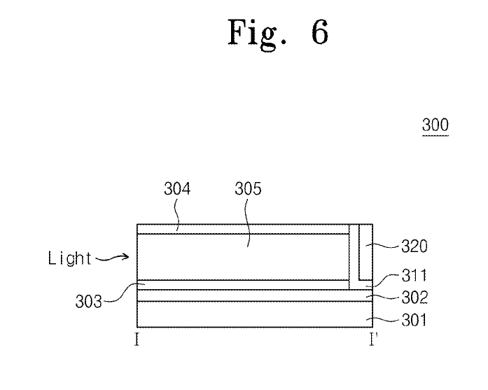

Reference is made to FIG. 6, which is a cross-sectional view taken along the line I-I′ of a waveguide photomixer in FIG. 5. Unlike typical waveguide photomixers, the waveguide photomixer 300 is characterized in that an absorption layer is partially removed through a selective etching process to have a smaller junction area than a first clad layer and a second clad layer. Thus, junction capacitance may be made low. As a result, an RC time constant may be made small to improve operating speed of a photomixer. However, since the absorption layer is partially removed through a selective etching process, a length of the absorption layer may be reduced to absorb insufficient amount of light.

If the amount of absorbed light is not sufficient, responsivity of a photomixer may be reduced. However, the waveguide photomixer 300 in FIG. 5 further includes the high-reflection layer 320 disposed on a surface opposite to a light-impinging surface of a mesa structure to re-reflect light passing through an absorption layer to the absorption layer. Thus, reduction of the responsivity may be suppressed.

The high-reflection layer 320 reflects light that is not sufficiently absorbed while passing through an absorption layer. The reflected light is re-absorbed to the absorption layer to be used for generation of electron-hole pairs. As a result, reduction of responsivity may be suppressed and operating speed may be improved.

The high-reflection layer 320 may be made of a single layer of metallic material or a single layer of dielectric substance. In order to increase reflection efficiency, the high-reflection layer 320 may be formed by stacking a plurality of dielectric substances with different refractive indexes. The high-reflection layer 320 may be made of the same material as a P-electrode unit that may be the second electrode unit 304. In this case, the high-reflection layer 320 may be formed simultaneously to formation of the P-electrode unit. The high-reflection layer 320 may be made of one of Ti/Au, Ti/Pt/Au, and Ti/Pt/Au/Ni.

The protection layer 311 is formed to block current between the high-reflection layer 320 and adjacent elements (the second electrode unit 304, the first electrode unit 303, and the buffer layer 302) and achieve electrical isolation between elements.

According to the waveguide photomixers described so far, responsivity and operating speed can be improved.

While the inventive concept has been particularly shown and described with reference to exemplary embodiments thereof, it will be apparent to those of ordinary skill in the art that various changes in form and detail may be made therein without departing from the spirit and scope of the inventive concept as defined by the following claims.

What is claimed is:

1. A waveguide photomixer comprising:
a buffer layer disposed on a substrate;
a first clad layer disposed on the buffer layer and formed to have smaller width than that of a top surface of the buffer layer;
an absorption layer disposed on the first clad layer and formed to have smaller width than that of a top surface of the first clad layer;
a second clad layer disposed on the absorption layer and formed to have greater width than that of a top surface of the absorption layer;
a contact layer disposed on the second clad layer;
a first electrode unit disposed on the buffer layer where the first clad layer is not disposed; and
a second electrode unit disposed on the contact layer.

2. The waveguide photomixer as set forth in claim 1, wherein the absorption layer has a smaller junction area than that of the first and second clad layers.

3. The waveguide photomixer as set forth in claim 1, wherein the buffer layer, the first clad layer, the absorption layer, the second clad layer, and the contact layer are sequentially stacked to be formed, and
on the basis of a central region, both sides of the contact layer, the second clad layer, the absorption layer, and the first clad layer are etched to form a mesa structure.

4. The waveguide photomixer as set forth in claim 3, wherein the buffer layer is an N-buffer layer,
the first clad layer is an N-clad layer doped with N-type impurities,
the second clad layer is a P-clad layer doped with P-type impurities,
the contact layer is a P-contact layer,
the first electrode unit is an N-electrode unit, and
the second electrode unit is a P-electrode unit.

5. The waveguide photomixer as set forth in claim 4, further comprising:
a high-reflection layer disposed on a surface opposite to a light-impinging surface of the mesa structure to re-reflect light passing through the absorption layer to the absorption layer.

6. The waveguide photomixer as set forth in claim 5, wherein the high-reflection layer is made of a single layer of metallic material or a single layer of dielectric.

7. The waveguide photomixer as set forth in claim 5, wherein the high-reflection layer is made of the same material as the P-electrode unit and formed simultaneously to formation of the P-electrode unit.

8. The waveguide photomixer as set forth in claim 5, wherein the high-reflection layer is made of one of Ti/Au, Ti/Pt/Au, and Ti/Pt/Au/Ni.

9. The waveguide photomixer as set forth in claim 5, wherein the high-reflection layer is formed by stacking a plurality of dielectrics with different refractive indexes.

10. The waveguide photomixer as set forth in claim 4, wherein the absorption layer is made of InGaAs, and
the first and second clad layers are made of InGaAsP or InP.

11. The waveguide photomixer as set forth in claim 3, wherein a refractive index of the first and second clad layers is lower than that of the absorption layer.

12. The waveguide photomixer as set forth in claim 3, further comprising:
a protection layer disposed on the buffer layer and a side surface of the mesa structure to block current and achieve electrical isolation between elements.
